(19) United States
(12) Patent Application Publication
(10) Pub. No.: US 2025/0235778 A1
(43) Pub. Date: Jul. 24, 2025

(54) MASTER CONTROL SYSTEM OF ATMOSPHERE SYSTEM AND ANDROID MANIPULATION SYSTEM THEREOF

(71) Applicant: GuangZhou DreamFuns Amusement Technology Co., Ltd, Guangzhou City (CN)

(72) Inventors: Yongfeng LU, Guangzhou City (CN); Sijin CHEN, Guangzhou City (CN)

(73) Assignee: GuangZhou DreamFuns Amusement Technology Co., Ltd, Guangzhou City (CN)

(21) Appl. No.: 18/940,656

(22) Filed: Nov. 7, 2024

(30) Foreign Application Priority Data
Jan. 23, 2024 (CN) 2024100963046

(51) Int. Cl. A63F 13/23; G05B 15/02

(52) U.S. Cl. CPC A63F 13/23; G05B 15/02

(57) ABSTRACT

Master control system of atmosphere system and Android manipulation system are provided. Master computer is provided and master computer is connected to slave computer, gift machine body, and gift machine lattice screen, wherein gift machine lattice screen is electrically connected to master computer, and gift machine lattice screen and master computer communicate with each other to transmit instructions; slave computer is electrically connected to master computer, and slave computer and master computer communicate with each other to transmit instructions; and gift machine body is electrically connected to slave computer, and gift machine body and slave computer communicate with each other to transmit instructions, wherein master computer is further connected to Android program and hanging ring host; master computer is electrically connected to hanging ring host; and master computer and hanging ring host communicate with each other to transmit instructions.

### CROSS-REFERENCE TO RELATED APPLICATION

The present disclosure claims the priority to the Chinese patent application with the filling No. 2024100963046 filed with the Chinese Patent Office on Jan. 23, 2024, the contents of which are incorporated herein by reference in entirety.

### TECHNICAL FIELD

The present disclosure relates to the technical field of the atmosphere system of gift machines, and in particular to a master control system of an atmosphere system and an Android manipulation system thereof.

### BACKGROUND ART

The video game consoles include several major types: analog machine, lottery machine, coin pusher, frame machine, gift machine, etc. All machines that can acquire gifts by a certain game are called as the gift machines. The gift machine is provided for players to experience based on selling gifts plus some different play ways, and in the experience process, the user can both experience fun of the game, and can obtain the gifts by their skills. Compared to the single function of selling gifts, the gift machine can provide more fun and exciting process of playing games.

At present, the gift machine is provided for players to experience based on selling gifts plus some different play ways, and is mainly arranged in shopping malls and other densely populated public places. However, the traditional gift machine is too monotonous. It is not easy to effectively interact with players, and the players are also difficult to interact with each other. Therefore, it is not attractive enough for players. In view of this, the present disclosure provides a master control system of an atmosphere system and an Android manipulation system thereof.

### SUMMARY

In order to overcome deficiencies in the prior art and adapt to realistic requirements, the present disclosure provides a master control system of an atmosphere system and an Android manipulation system to solve the technical problems that the present gift machine is not easy to effectively interact with players, and the players are also difficult to interact with each other, so that it is not attractive enough for the players.

In order to realize the objects of the present disclosure, the present disclosure adopts the following technical solutions. A master control system of the atmosphere system and the Android manipulation system are designed, including a master computer, wherein
the master computer is connected to a slave computer, a gift machine body, and a gift machine lattice screen, wherein the gift machine lattice screen is electrically connected to the master computer, and the gift machine lattice screen and the master computer communicate with each other to transmit instructions; the slave computer is electrically connected to the master computer, and the slave computer and the master computer communicate with each other to transmit instructions; and the gift machine body is electrically connected to the slave computer, and the gift machine body and the slave computer communicate with each other to transmit instructions, wherein
the master computer is further connected to an Android program and a hanging ring host, wherein the master computer is electrically connected to the hanging ring host, and the master computer and the hanging ring host communicate with each other to transmit instructions; and the Android program and master computer communicate with each other to transmit instructions, and the hanging ring host is connected to a hanging ring lattice screen, wherein the hanging ring lattice screen is electrically connected to the hanging ring host, and the hanging ring lattice screen and the hanging ring host communicate with each other to transmit instructions.

An Android manipulation system includes a master control box, wherein the master control box is connected to a sending card, and the master control box is operated and controlled by an operator, wherein the sending card is connected to a receiving card, and the receiving card is connected to an advertising screen, wherein the master control box is electrically connected to the sending card, and the master control box communicates and transmits instructions to the sending card; the receiving card is electrically connected to the sending card, and the sending card communicates and transmits instructions to the receiving card; and the receiving card is electrically connected to the advertising screen, and the receiving card communicates and transmits instructions to the advertising screen.

Preferably, the master control box is a master control terminal, wherein the master control terminal includes a data input device and a PC for receiving data; the PC is electrically connected to a display module and a power amplifier module, and the PC is configured to communicate and transmit instructions to the display module and the power amplifier module; and the power amplifier module is electrically connected to a wireless microphone module, and the power amplifier module is configured to communicate and transmit instructions to the wireless microphone module.

Preferably, the PC is electrically connected to a synchronous sending module and a single chip microcontroller; the PC communicates and transmits instructions to the synchronous sending module; and the PC is electrically connected to the single chip microcontroller by a USB-to-serial-port communication, wherein the single chip microcontroller is electrically connected to a small-screen displaying and setting module, and the single chip microcontroller communicates and transmits instructions to the small-screen displaying and setting module; and the single chip microcontroller is further electrically connected to an address and parameter storing module, and the single chip microcontroller communicates and transmits instructions to the address and parameter storing module.

Preferably, a plurality of groups of machines (or units) are further provided, and a synchronous receiving card is arranged inside each machine, wherein the synchronous receiving card is electrically connected to the synchronous sending module, and the synchronous receiving card and the synchronous sending module transmit instructions via a network cable; and the synchronous receiving card is electrically connected to a lattice screen, and the synchronous receiving card communicates with the lattice screen for transmitting instructions.

Preferably, the machine further includes a small-screen displaying and setting module and a single chip microcontroller, wherein the small-screen displaying and setting module is electrically connected to the single chip microcontroller and they are communicated with each other to transmit instructions; the single chip microcontroller is arranged in the machine communicates and transmits instructions to the single chip microcontroller in the master control terminal via a network cable; the single chip microcontroller arranged in the machine is further electrically connected to an address and parameter storing module, a machine state acquisition, a coin signal acquisition, a button signal acquisition, and a gift machine prize-delivery communication.

Preferably, the address and parameter storing module is configured to store an IP address and internal parameter data of the machine; the machine state acquisition is configured to acquire a machine operating-state signal; the coin signal acquisition is configured to acquire a signal after inserting a coin is sensed inside the machine; and the button signal acquisition is configured to acquire a pressing signal of a button when operating the machine.

Preferably, the address and parameter storing module is configured to store an IP address and internal parameter data of the machine; the machine state acquisition is configured to acquire a machine operating-state signal; the coin signal acquisition is configured to acquire a signal after inserting a coin is sensed inside the machine; and the button signal acquisition is configured to acquire a pressing signal of a button when operating the machine.

Preferably, the address and parameter storing module includes a single-machine-position address memorizer, a dual-machine-position address memorizer, a player count memorizer, and an address memorizer of a hanging-ring control box, wherein the single-machine-position address memorizer is configured to store address information of a single-machine-position gift machine; the dual-machine-position address memorizer is configured to store address information of a dual-machine-position gift machine; the player count memorizer is configured to store information data of a historical player count; and the address memorizer of a hanging-ring control box is configured to store operating address information of the hanging-ring control box.

Preferably, the machine state acquisition includes operation state monitoring, player count monitoring, connection state monitoring, and fault information monitoring, wherein the operation state monitoring is configured to monitor an operation state of the machine; the player count monitoring is configured to monitor the player count playing the machine in real time; the connection state monitoring is configured to monitor a communication state of the gift machine; and the fault information monitoring is configured to monitor and transmit the fault information occurring in an operation process of the machine, wherein the button signal acquisition includes a start signal acquisition, a remote control signal acquisition, a selecting signal acquisition, and a rocker signal acquisition, wherein the start signal acquisition is configured to acquire and transmit a start button signal of the machine; the remote control signal acquisition is configured to acquire and transmit a remote control button signal of the machine; the selecting signal acquisition is configured to acquire and transmit a selecting button signal of the machine; and the rocker signal acquisition is configured to acquire and transmit a rocker signal of the machine.

Preferably, the gift machine prize-delivery communication includes a slave computer communication system, a master computer communication system, a gift machine lattice screen communication system, and a hanging ring host communication system, wherein the slave computer communication system, the master computer communication system, the gift machine lattice screen communication system, and the hanging ring host communication system communicate and transmit signals with the slave computer, the master computer, the gift machine lattice screen, and the hanging ring host respectively.

Compared to the prior art, the present disclosure includes the following beneficial effects. The Android program can send signals (e.g., starting the game or activity) to the master computer;

can also acquire and display the statistic date of the master computer; and at the same time can upload videos for the master computer to play. The master computer mainly interacts with the slave computer to monitor the gift machine, and the hanging ring host communicates with the master computer to transmit videos and cooperatively display the content on the annular lattice screen. The player uploads the videos to the master computer by the Android program for the master computer to play them, which increases the interactivity between the players and the gift machine; and the players can also send instructions to the master computer by the Android program to interact with each other, which is beneficial to improve the attraction to the players.

### BRIEF DESCRIPTION OF DRAWINGS

FIG. 1 shows a system framework schematic diagram of an atmosphere system of the present disclosure;

FIG. 2A shows a system framework schematic diagram of an operating system of the present disclosure;

FIG. 2B shows a system framework schematic diagram of an operating system of the present disclosure;

FIG. 2C shows a system framework schematic diagram of an operating system of the present disclosure;

FIG. 3 shows an operation process schematic diagram of an operating system of the present disclosure;

FIG. 4 shows a system framework schematic diagram of an address and parameter storing module of the present disclosure;

FIG. 5 shows a system framework schematic diagram of a machine state acquisition of the present disclosure;

FIG. 6 shows a system framework schematic diagram of a button signal acquisition of the present disclosure; and

FIG. 7 shows a system framework schematic diagram of a gift machine prize-delivery communication of the present disclosure.

Reference numbers: 1, master computer; 2, Android program; 3, gift machine lattice screen; 4, hanging ring host; 5, hanging ring lattice screen; 6, slave computer; 7, gift machine body; 8, operator; 9, master control box; 10, sending card; 11, receiving card; and 12, advertising screen.

### DETAILED DESCRIPTION OF EMBODIMENTS

The present disclosure is further described below in connection with drawings and embodiments.

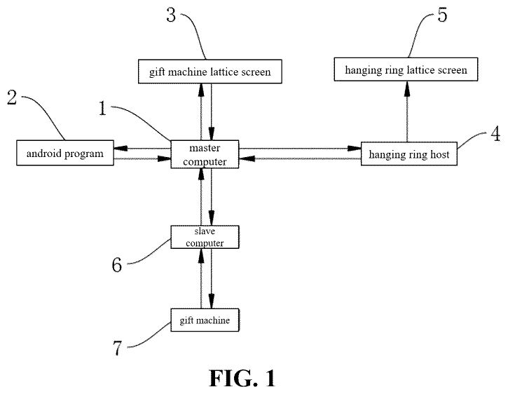

Embodiment 1: a master control system of an atmosphere system and an Android manipulation system thereof, referring to FIG. 1, includes a master computer 1, wherein the master computer 1 is connected to a slave computer 6, a gift machine body 7, and a gift machine lattice screen 3, wherein the gift machine lattice screen 3 is electrically connected to the master computer 1, and the gift machine lattice screen 3 and the master computer 1 communicate with each other to transmit instructions; the slave computer 6 is electrically connected to the master computer 1, and the slave computer 6 and the master computer 1 communicate with each other to transmit instructions; and the gift machine body 7 is electrically connected to the slave computer 6, and the gift machine body 7 and the slave computer 6 communicate with each other to transmit instructions, wherein the master computer 1 is further connected to an Android program 2 and a hanging ring host 4, wherein the master computer 1 is electrically connected to the hanging ring host 4, and the master computer 1 and the hanging ring host 4 communicate with each other to transmit instructions; and the Android program 2 and master computer 1 communicate with each other to transmit instructions, and the hanging ring host 4 is connected to a hanging ring lattice screen 5, wherein the hanging ring lattice screen 5 is electrically connected to the hanging ring host 4, and the hanging ring lattice screen 5 and the hanging ring host 4 communicate with each other to transmit instructions.

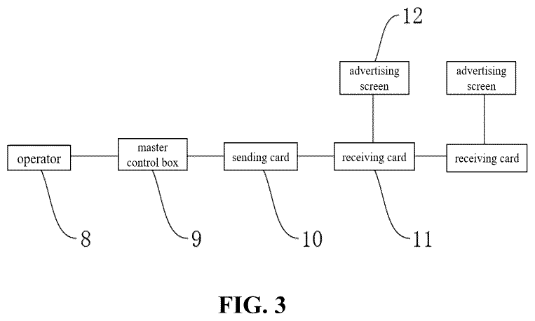

An Android manipulation system, referring to FIG. 3, includes a master control box 9, wherein the master control box 9 is connected to a sending card 10, and the master control box 9 is operated and controlled by an operator 8; the sending card 10 is connected to a receiving card 11; and the receiving card 11 is connected to an advertising screen 12, wherein the master control box 9 is electrically connected to the sending card 10, and the master control box 9 communicates and transmits instructions to the sending card 10; the receiving card 11 is electrically connected to the sending card 10, and the sending card 10 communicates and transmits instructions to the receiving card 11; and the receiving card 11 is electrically connected to the advertising screen 12, and the receiving card 11 communicates and transmits instructions to the advertising screen 12.

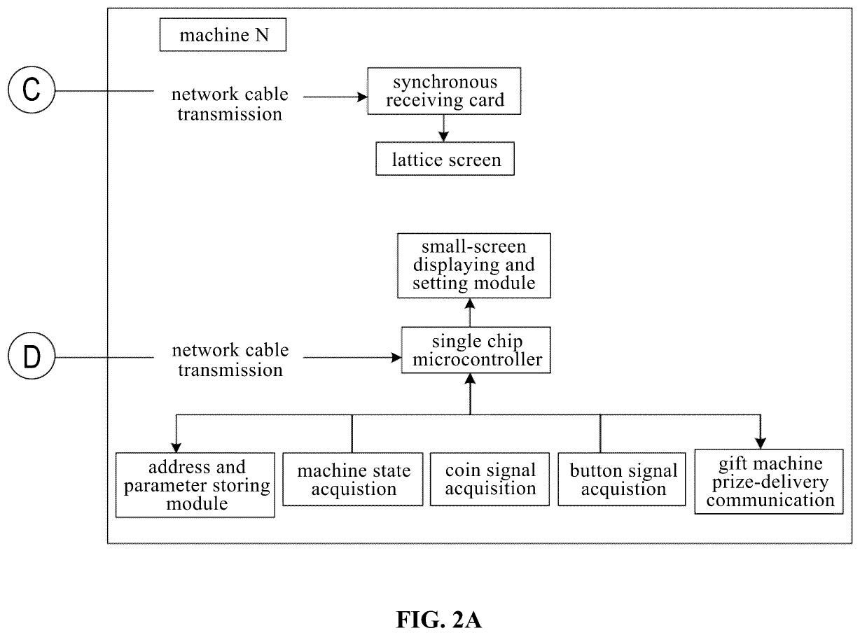

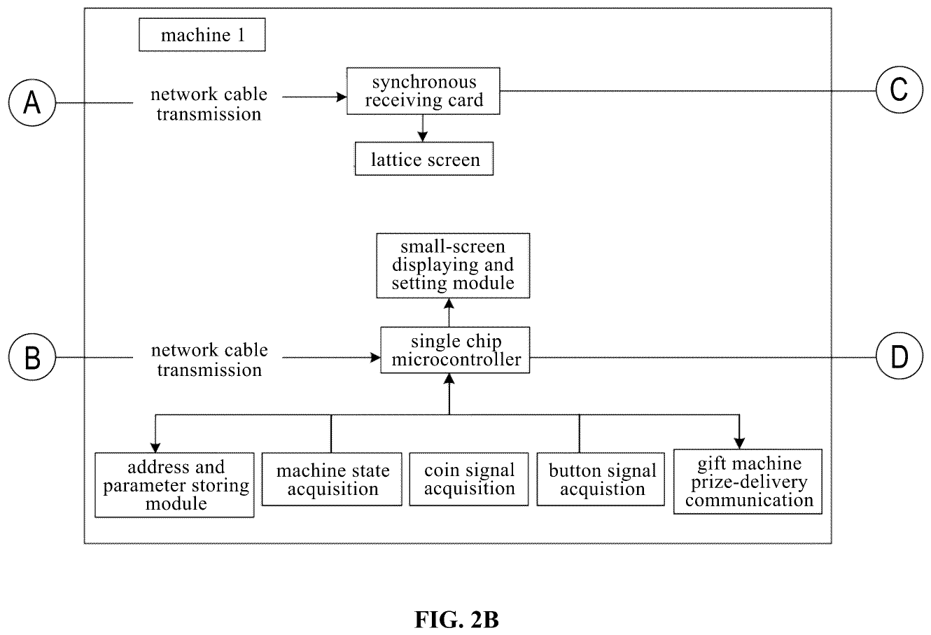

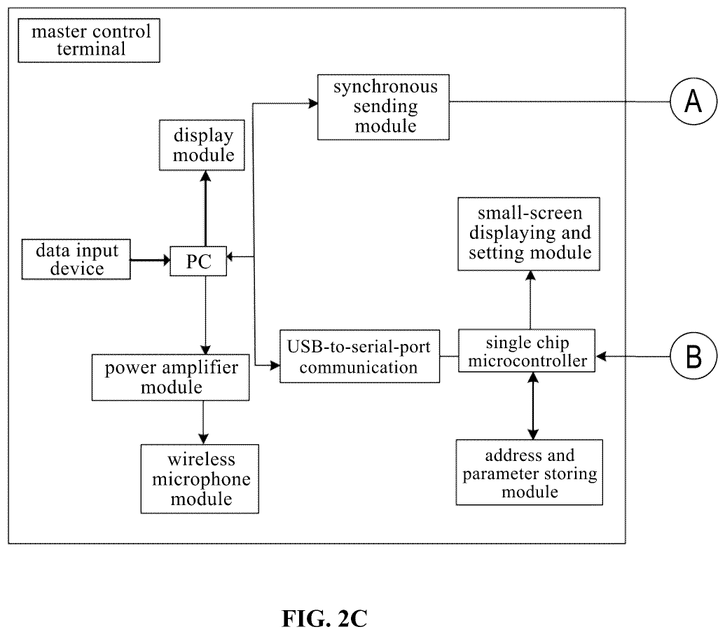

Referring to FIGS. 2A-C and FIG. 3, the master control box 9 is a master control terminal, wherein the master control terminal includes a data input device and a PC for receiving data; the PC is electrically connected to a display module and a power amplifier module, and the PC is configured to communicate and transmit instructions to the display module and the power amplifier module; and the power amplifier module is electrically connected to a wireless microphone module, and the power amplifier module is configured to communicate and transmit instructions to the wireless microphone module. The PC is electrically connected to a synchronous sending module and a single chip microcontroller, wherein the synchronous sending module is the sending card 10, and the PC communicates with the synchronous sending module and transmits instructions. The PC is electrically connected to the single chip microcontroller by a USB-to-serial-port communication, wherein the single chip microcontroller is electrically connected to a small-screen displaying and setting module, and the single chip microcontroller communicates and transmits instructions to the small-screen displaying and setting module; and the single chip microcontroller is further electrically connected to an address and parameter storing module, and the single chip microcontroller communicates and transmits instructions to the address and parameter storing module.

Referring to FIGS. 2A-C, a plurality of groups of machines are further provided, wherein a synchronous receiving card is arranged inside each machine, and the synchronous receiving card is the receiving card 11, wherein the synchronous receiving card is electrically connected to the synchronous sending module, and the synchronous receiving card and the synchronous sending module transmit instructions via a network cable; and the synchronous receiving card is electrically connected to a lattice screen, and the synchronous receiving card communicates with the lattice screen for transmitting instructions. The machine further includes a small-screen displaying and setting module and the single chip microcontroller, wherein the small-screen displaying and setting module is electrically connected to the single chip microcontroller and they are communicated with each other to transmit instructions; the single chip microcontroller arranged in the machine communicates and transmits instructions to the single chip microcontroller in the master control terminal via a network cable; and the single chip microcontroller arranged in the machine is electrically connected to an address and parameter storing module, a machine state acquisition, a coin signal acquisition, a button signal acquisition, and a gift machine prize-delivery communication, wherein the address and parameter storing module is configured to store an IP address and internal parameter data of the machine; the machine state acquisition is configured to acquire a machine operating-state signal; the coin signal acquisition is configured to acquire a signal after inserting a coin is sensed inside the machine; and the button signal acquisition is configured to acquire a pressing signal of a button when operating the machine, wherein the information acquired by the address and parameter storing module, the machine state acquisition, the coin signal acquisition, the button signal acquisition, and the gift machine prize-delivery communication is transmitted to the small-screen displaying and setting module by the single chip microcontroller inside the machine, and the acquired information is displayed by the small-screen displaying and setting module.

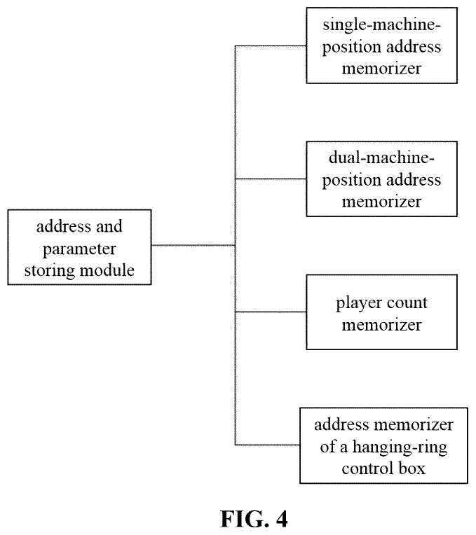

Referring to FIG. 3 and FIG. 4, the address and parameter storing module is configured to store an IP address and internal parameter data of the machine; the machine state acquisition is configured to acquire a machine operating-state signal; the coin signal acquisition is configured to acquire a signal after inserting a coin is sensed inside the machine; and the button signal acquisition is configured to acquire a pressing signal of a button when operating the machine, wherein the address and parameter storing module includes a single-machine-position address memorizer, a dual-machine-position address memorizer, a player count memorizer, and an address memorizer of a hanging-ring control box, wherein the single-machine-position address memorizer is configured to store address information of a single-machine-position gift machine; the dual-machine-position address memorizer is configured to store address information of a dual-machine-position gift machine; the player count memorizer is configured to store information data of a historical player count; and the address memorizer of a hanging-ring control box is configured to store operating address information of the hanging-ring control box, wherein the single-machine-position address memorizer and the dual-machine-position address memorizer establish a connection with the PC by the single chip microcontrollers and the USB-to-serial-port communication, and are configured to transmit the address information data.

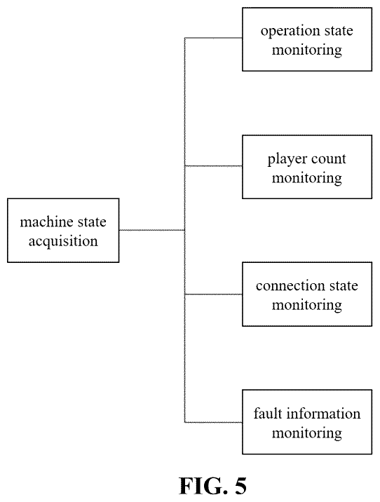

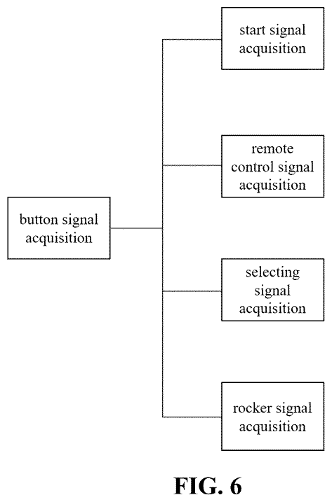

Referring to FIG. 5 and FIG. 6, the machine state acquisition includes operation state monitoring, player count monitoring, connection state monitoring, and fault information monitoring, wherein the operation state monitoring is configured to monitor an operation state of the machine; the player count monitoring is configured to monitor the player count playing the machine in real time; the connection state monitoring is configured to monitor a communication state of the gift machine; and the fault information monitoring is configured to monitor and transmit the fault information occurring in an operation process of the machine, wherein the machine state acquisition establishes a connection with the PC by the single chip microcontrollers and the USB-to-serial-port communication, and is configured to transmit the machine state information to the PC in data transmission. The button signal acquisition includes a start signal acquisition, a remote control signal acquisition, a selecting signal acquisition, and a rocker signal acquisition, wherein the start signal acquisition is configured to acquire and transmit a start button signal of the machine; the remote control signal acquisition is configured to acquire and transmit a remote control button signal of the machine; the selecting signal acquisition is configured to acquire and transmit a selecting button signal of the machine; and the rocker signal acquisition is configured to acquire and transmit a rocker signal of the machine, wherein the button signal acquisition is configured to acquire press states of the start button, remote control button, selecting button, and rocker button on the machine, and establish a connection with the PC by the single chip microcontrollers and the USB-to-serial-port communication to transmit the pressing signals of the button.

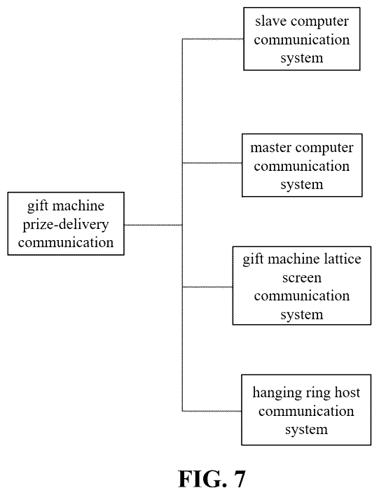

Referring to FIG. 7, the gift machine prize-delivery communication includes a slave computer communication system, a master computer communication system, a gift machine lattice screen communication system, and a hanging ring host communication system, wherein the slave computer communication system, the master computer communication system, the gift machine lattice screen communication system, and the hanging ring host communication system communicate and transmit signals with the slave computer 6, the master computer 1, the gift machine lattice screen 3, and the hanging ring host 4 respectively.

The master computer 1 interacts with the slave computer 6 by the serial communication, so that the master computer 1 can manipulate the hardware.

The master computer 1 searches the network IP address corresponding to the android control program in a UDP broadcast communication mode, and then communicates with the Android program 2 by Socket, so that the Android program 2 can automatically connect and interact with the master computer 1.

The screen layout of the lattice screen can be realized through the cutting and combination for the screen contents by the master computer 1.

The computer software mainly includes three parts: the master computer 1, the hanging ring host 4, and the Android program 2, wherein the master computer 1 mainly controls interactions in each part and the lattice screen display of the gift machine body 7; the hanging ring host 4 mainly displays the content of the hanging ring lattice screen 5; and the Android program 2 mainly communicates with the master computer 1 to send the manipulation instructions to the master computer 1 and acquires various data.

The gift machine can be provided with a QR code, and the player enters inside the Android program 2 by scanning the QR code and sends relevant instructions by the Android program 2.

The working principle is as follows. The player sends the instruction to the master computer 1 by the Android program 2, and the master computer 1 transmits the instruction to the slave computer 6; the master computer 1 transmits the instruction to the gift machine lattice screen 3, and the gift machine lattice screen 3 displays the content of the instruction; or the master computer 1 can further transmit the instruction to the hanging ring host 4 and the hanging ring master host 4 transmits the instruction to the hanging ring lattice screen 5, and the hanging ring lattice screen 5 displays the content of the instruction. The master computer 1 and the slave computer 6 communicate and interact with each other, which can transmit the instructions issued by the Android program 2; at the same time the instruction information of the gift machine body 7 can be interacted by the slave computer 6 and the master computer 1, and the instruction is transmitted to the gift machine lattice screen 3 and the hanging ring lattice screen 5 by the master computer 1; or the master computer 1 can transmit it to the player by the Android program 2, so that the gift machine body 7 interacts with the master computer 1.

The embodiments disclosed by the present disclosure are preferred embodiments, but are not limited thereto. It is extremely easy for a person of ordinary skill in the art to understand the spirit of the present disclosure based on the above embodiments and to make different extensions and variations, and they are all within the scope of protection of the present disclosure without departing from the spirit of the present disclosure.

1. A master control system of an atmosphere system, comprising a master computer, wherein
the master computer is connected to a slave computer, a gift machine body, and a gift machine lattice screen, wherein the gift machine lattice screen is electrically connected to the master computer, and the gift machine lattice screen and the master computer communicate with each other to transmit instructions; the slave computer is electrically connected to the master computer, and the slave computer and the master computer communicate with each other to transmit instructions; and the gift machine body is electrically connected to the slave computer, and the gift machine body and the slave computer communicate with each other to transmit instructions, wherein
the master computer is further connected to an Android program and a hanging ring host, wherein the master computer is electrically connected to the hanging ring host, and the master computer and the hanging ring host communicate with each other to transmit instructions; and the Android program and master computer communicate with each other to transmit instructions, and the hanging ring host is connected to a hanging ring lattice screen, wherein the hanging ring lattice screen is electrically connected to the hanging ring host, and the hanging ring lattice screen and the hanging ring host communicate with each other to transmit instructions.

2. An Android manipulation system, comprising the master control system of the atmosphere system according to claim 1, wherein a master control box is comprised, wherein the master control box is connected to a sending card, and the master control box is operated and controlled by an operator, wherein the sending card is connected to a receiving card, and the receiving card is connected to an advertising screen, wherein the master control box is electrically connected to the sending card, and the master control box communicates and transmits instructions to the sending card; the receiving card is electrically connected to the sending card, and the sending card communicates and transmits instructions to the receiving card; and the receiving card is electrically connected to the advertising screen, and the receiving card communicates and transmits instructions to the advertising screen.

3. The Android manipulation system according to claim 2, wherein the master control box is a master control terminal, and the master control terminal comprises a data input device and a PC for receiving data, wherein the PC is electrically connected to a display module and a power amplifier module, and the PC is configured to communicate and transmit instructions to the display module and the power amplifier module; and the power amplifier module is electrically connected to a wireless microphone module, and the power amplifier module is configured to communicate and transmit instructions to the wireless microphone module.

4. The Android manipulation system according to claim 3, wherein the PC is electrically connected to a synchronous sending module and a single chip microcontroller; the PC communicates and transmits instructions to the synchronous sending module; and the PC is electrically connected to the single chip microcontroller by a USB-to-serial-port communication, wherein the single chip microcontroller is electrically connected to a small-screen displaying and setting module, and the single chip microcontroller communicates and transmits instructions to the small-screen displaying and setting module; and the single chip microcontroller is further electrically connected to an address and parameter storing module, and the single chip microcontroller communicates and transmits instructions to the address and parameter storing module.

5. The Android manipulation system according to claim 4, wherein a plurality of groups of machines are further provided, and a synchronous receiving card is arranged inside each machine;
the synchronous receiving card is electrically connected to the synchronous sending module, and the synchronous receiving card and the synchronous sending module transmit instructions via a network cable; and the synchronous receiving card is electrically connected to a lattice screen, and the synchronous receiving card communicates with the lattice screen for transmitting instructions.

6. The Android manipulation system according to claim 5, wherein the machine further comprises a small-screen displaying and setting module and a single chip microcontroller, wherein the small-screen displaying and setting module is electrically connected to the single chip microcontroller and they are communicated with each other to transmit instructions; the single chip microcontroller arranged in the machine communicates and transmits instructions to the single chip microcontroller in the master control terminal via a network cable; the single chip microcontroller arranged in the machine is further electrically connected to an address and parameter storing module, a machine state acquisition, a coin signal acquisition, a button signal acquisition, and a gift machine prize-delivery communication.

7. The Android manipulation system according to claim 6, wherein the address and parameter storing module is configured to store an IP address and internal parameter data of the machine; the machine state acquisition is configured to acquire a machine operating-state signal; the coin signal acquisition is configured to acquire a signal after inserting a coin is sensed inside the machine; and the button signal acquisition is configured to acquire a pressing signal of a button when operating the machine.

8. The Android manipulation system according to claim 6, wherein the address and parameter storing module comprises a single-machine-position address memorizer, a dual-machine-position address memorizer, a player count memorizer, and an address memorizer of a hanging-ring control box, wherein the single-machine-position address memorizer is configured to store address information of a single-machine-position gift machine; the dual-machine-position address memorizer is configured to store address information of a dual-machine-position gift machine; the player count memorizer is configured to store information data of a historical player count; and
the address memorizer of the hanging-ring control box is configured to store operating address information of the hanging-ring control box.

9. The Android manipulation system according to claim 6, wherein the machine state acquisition comprises operation state monitoring, player count monitoring, connection state monitoring, and fault information monitoring, wherein the operation state monitoring is configured to monitor an operation state of the machine; the player count monitoring is configured to monitor a player count playing the machine in real time; the connection state monitoring is configured to monitor a communication state of the gift machine; and the fault information monitoring is configured to monitor and transmit fault information occurring in an operation process of the machine, wherein the button signal acquisition comprises a start signal acquisition, a remote control signal acquisition, a selecting signal acquisition, and a rocker signal acquisition, wherein the start signal acquisition is configured to acquire and transmit a start button signal of the machine; the remote control signal acquisition is configured to acquire and transmit a remote control button signal of the machine; the selecting signal acquisition is configured to acquire and transmit a selecting button signal of the machine; and the rocker signal acquisition is configured to acquire and transmit a rocker signal of the machine.

10. The Android manipulation system according to claim 6, wherein the gift machine prize-delivery communication comprises a slave computer communication system, a master computer communication system, a gift machine lattice screen communication system, and a hanging ring host communication system, wherein the slave computer communication system, the master computer communication system, the gift machine lattice screen communication system, and the hanging ring host communication system communicate and transmit signals to the slave computer, the master computer, the gift machine lattice screen, and the hanging ring host respectively.
